(19) United States
(12) Patent Application Publication
(10) Pub. No.: US 2022/0114278 A1
(43) Pub. Date: Apr. 14, 2022

(54) PERSONAL INFORMATION PROTECTION DEVICE, PERSONAL INFORMATION PROTECTION METHOD AND PROGRAM

(71) Applicant: NIPPON TELEGRAPH AND TELEPHONE CORPORATION, Tokyo (JP)

(72) Inventors: Taichi KAWABATA, Musashino-shi, Tokyo (JP); Kimihiro MIZUTANI, Musashino-shi, Tokyo (JP)

(73) Assignee: NIPPON TELEGRAPH AND TELEPHONE CORPORATION, Tokyo (JP)

(21) Appl. No.: 17/276,980

(22) PCT Filed: Sep. 6, 2019
(86) PCT No.: PCT/JP2019/035102

§ 371 Date: Dec. 21, 2021

(30) Foreign Application Priority Data
Sep. 20, 2018 (JP) 2018-175811

(51) Int. Cl. G06F 21/62; G06F 21/60

(52) U.S. Cl. CPC G06F 21/6245; G06F 21/604

(57) ABSTRACT

An object of the present invention is to provide a personal information protection apparatus, a personal information protection method, and a program that make it possible to easily control a range of personal information to be provided to an application. The personal information protection apparatus according to the present invention performs machine learning on terms of use, classifications, and access settings of applications installed in a terminal, and holds them as a user policy, and when an attempt is made to change the access settings of a certain application, presents, to the user, recommended settings based on the user policy. When the user changes access settings of an application based on a policy that is different from the prior and existing policy, this personal information protection apparatus performs learning on the user policy again using the changed access settings.

### TECHNICAL FIELD

The present disclosure relates to a personal information protection apparatus, a personal information protection method, and a program for controlling a range of personal information to be provided to an application, the personal information being generated by a device that is owned by a user, and generates information on an individual, and the application being an application that uses the device.

### BACKGROUND ART

Some devices owned by individuals have various sensors mounted therein, and obtain information obtained by the sensors and various types of information that includes personal information stored in a storage apparatus in the devices, and in such devices, an application that provides a service to the user can be installed. Typical examples of the above-described devices include a smartphone and a tablet. In addition, some small-sized devices obtain or collect information on individuals, and transmit the information to the above-described device or application using a network technique.

In a device (smart phone or the like) of today in which applications can be installed, the operating system (hereinafter, OS) that operates on the device can control a range of information that an application can obtain from a device or a memory, for the user. Most applications transmit obtained information to a network service on the Internet, and provide a service to the user as a result of the network service processing a request from the applications.

### CITATION LIST

### Non Patent Literature

[NPL 1] A. Cooper, J. Morris, and E. Newland, “Privacy Rulesets: A User-Empowering Approach to Privacy on the Web”, W3C Privacy Workshop (July, 2010) http://www.w3.org/2010/api-privacy-ws/papers/privacy-ws-12.html (retrieved on Aug. 24, 2018)

### SUMMARY OF THE INVENTION

### Technical Problem

In recent years, with diversification of devices, an increase in the number of types of information, and an increase in the variety of applications, it has gradually become difficult for the users to control distribution of their own information on individuals (personal information). Furthermore, as network services are internationalized, there have been more and more opportunities to use foreign services to which domestic laws are not applied, and there has been an increasing risk that personal information is used without being protected under domestic laws.

On the other hand, terms of use for applications and network services have been made longer, and it has been difficult for the user, when installing an application, to understand how much rights are guaranteed, what responsibilities the user assumes, and, if there is a conflict, laws of which country are applied, in order to use a service.

FIG. 1 is a diagram illustrating issue 1 that is to be solved. As in FIG. 1, when an application is installed, access permission is set from OS, but, in most cases, terms of use are read after the access permission setting (in actuality, terms of use are not read). An access permission setting screen and a terms of use screen are different, and the user cannot check those screens at the same time, and thus there has been an issue (issue 1) that changing access permission after reading terms of use is a great burden to the user.

FIG. 2 is a diagram illustrating issue 2 that is to be solved. With a current OS of today, as in FIG. 2, access permission settings of applications set in the past cannot be taken over, and thus there has been an issue (issue 2-1) that, every time an application is installed, access permission needs to be set, which is troublesome. In addition, even if the user changes the policy (viewpoint) regarding provision of their personal information at a certain point of time, a change in the access permission settings due to this change is not reflected on applications installed in the past. There has been an issue (issue 2-2) that, in order to change the policy for all of the applications, it is required to change the access permission of each all of the applications, and the burden to the user is great.

In view of this, it is an object of the present invention to provide a personal information protection apparatus, a personal information protection method, and a program that make it possible to easily control a range of personal information to be provided to an application, in order to reduce the above-described burdens on the user.

### Means for Solving the Problem

In order to achieve the above-mentioned purpose, a personal information protection apparatus according to one aspect of the invention performs machine learning on terms of use, classifications, and access settings of applications installed in a terminal, holds the terms of use, classifications, and access settings as a user policy, and when an attempt is made to change the access settings of a certain application, presents, to the user, recommended settings based on the user policy.

Specifically, the personal information protection apparatus according to another aspect of the invention is a personal information protection apparatus that manages, by application, permitted information that is a type (or types) of personal information of a user, and is to be used by an application that is installed in a terminal, the apparatus including: a learning function of holding a user policy of the user learned from terms of use, classifications, and permitted information for a plurality of applications installed in the terminal; and a checking function of presenting, to the user, permitted information that is recommended based on the user policy when a setting of permitted information for one application is changed.

In addition, a personal information protection method according to another aspect of the invention is a personal information protection method for managing, by application, permitted information that is a type of personal information of a user, and is to be used by an application that is installed in a terminal, the method comprising: a learning procedure of holding a user policy of the user learned from terms of use, classifications, and permitted information for a plurality of applications installed in the terminal; and a checking procedure of presenting, to the user, permitted information that is recommended based on the user policy when a setting of permitted information for one application is changed.

When the user attempts to change the settings (access settings) of a type of personal information that can be used for a certain application (permitted information), this personal information protection apparatus presents, to the user, access settings that are based on the user policy obtained through learning performed so far, from the terms of use and classification of the application. Therefore, the user can perform access setting of the application in accordance with the prior and existing policy without checking the terms of use of the application. Therefore, according to the present invention, it is possible to solve issue 1 and issue 2-1, and to provide a personal information protection apparatus and a personal information protection method that make it possible to easily control a range of personal information to be provided to an application.

Furthermore, in the learning function of the personal information protection apparatus according to another aspect of the invention, when the permitted information for the one application is changed, learning is performed again using the changed permitted information, and the user policy is updated, and, in the checking function, permitted information recommended for another application is presented to the user based on the user policy updated by the learning function.

In addition, in the learning procedure of the personal information protection method according to another aspect of the invention, when the permitted information for the one application is changed, learning is performed again using the changed permitted information, and the user policy is updated, and, in the checking procedure, permitted information recommended for another application is presented to the user based on the user policy updated by the learning function.

When the user changes access settings of a certain application in accordance with a policy different from the prior and existing policy, this personal information protection apparatus performs learning of the user policy again using the changed access settings. Furthermore, the user is asked to check whether or not access settings of another application that are affected before and after the learning that is performed again can also be changed. Specifically, when the policy on access settings is changed for one application, this personal information protection apparatus prompts the user to change access settings of another application that is relevant. Therefore, according to the present invention, it is possible to solve issue 2-2, and to provide a personal information protection apparatus and a personal information protection method that make it possible to easily control a range of personal information to be provided to an application. Note that it suffices for the user to check, as necessary, whether or not to change access settings of another application that is affected before and after learning that is performed again, and this processing does not need to be performed every time settings are changed.

Note that it is preferred to further provide a change function of changing settings of the permitted information for the application to the permitted information presented to the user by the checking function when an instruction is given from the user, the instruction indicating that a change can be made. Instead of automatically completing a change of access settings, user's intention can be reflected by the user checking whether or not the change can be made, and making the change when the user confirms that the change can be made.

A program according to another aspect of the invention is a program for causing a computer to function as the personal information protection apparatus. The personal information protection apparatus according to the present invention can also be realized by the computer and the program, and the program can be recorded in a recording medium, or can also be provided through a network.

Note that the above-described aspects of the invention can be combined wherever possible.

### Effects of the Invention

According to the present invention, it is possible to provide a personal information protection apparatus, a personal information protection method, and a program that make it possible to easily control a range of personal information to be provided to an application.

### BRIEF DESCRIPTION OF DRAWINGS

FIG. 1 is a diagram illustrating an issue of the present invention.

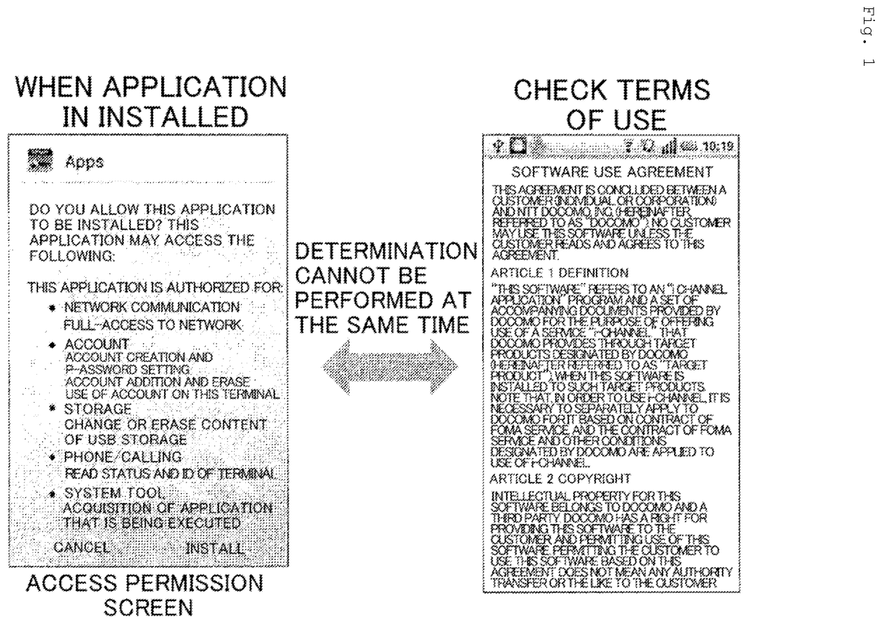

FIG. 2 is a diagram illustrating issues of the present invention.

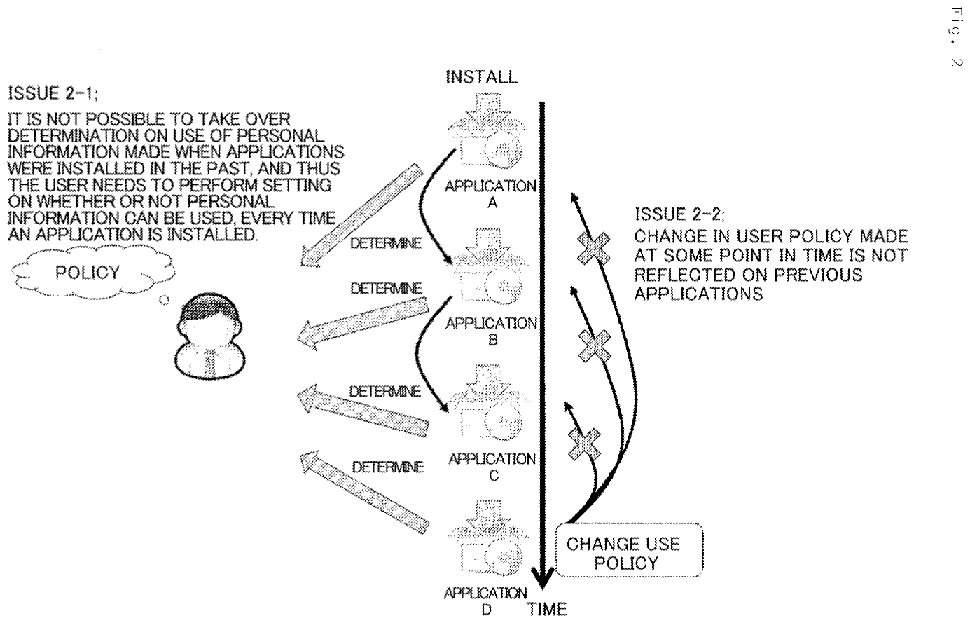

FIG. 3 is a diagram illustrating a personal information protection apparatus according to the present invention.

FIG. 4 is a diagram illustrating a term-of-use vector that is used by a personal information protection apparatus according to the present invention.

FIG. 5 is a diagram illustrating a personal information protection method according to the present invention.

### DESCRIPTION OF EMBODIMENTS

Hereinafter, an embodiment of the present invention is described with reference to the drawings. The embodiment to be described below is a working example of the present invention, and the present invention is not limited to the following embodiment. Note that, in the present specification and drawings, those denoted by the same reference numerals indicate the same constituent elements.

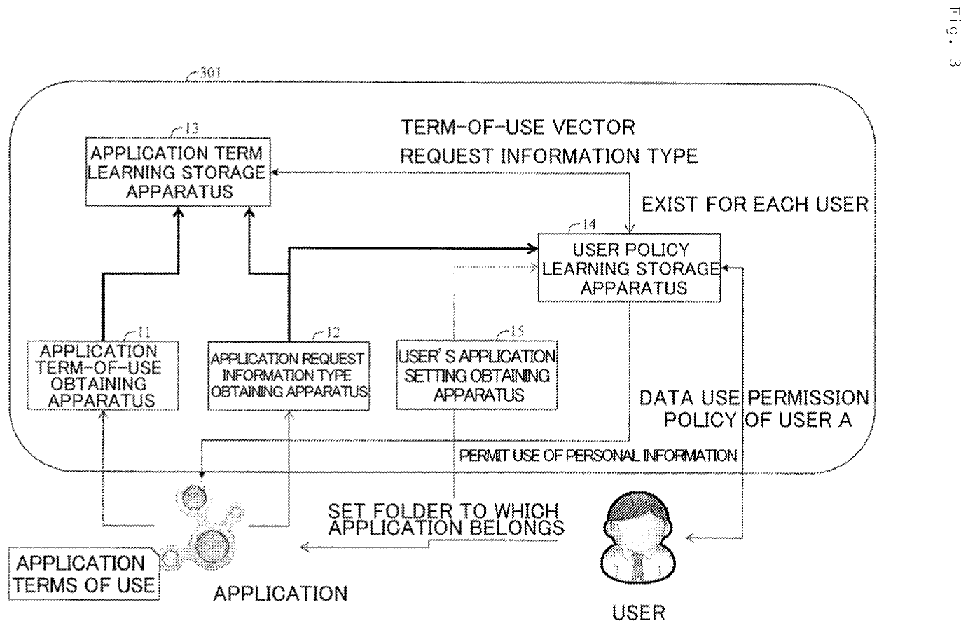

FIG. 3 is a diagram illustrating a personal information protection apparatus 301 according to this embodiment. The personal information protection apparatus 301 includes an application term-of-use obtaining apparatus 11, an application request information type obtaining apparatus 12, an application term learning storage apparatus 13, a user policy learning storage apparatus 14, and a user's application setting obtaining apparatus 15.

The application term-of-use obtaining apparatus 11 is an apparatus that obtains the terms of use of an application written in a natural language. This apparatus can obtain the terms of use of an application using the following method.
a) The content of a package file that constitutes an application is retrieved, and terms-of-use text is extracted.
b) The Web is searched using a URL written in manifest information of the application.
c) A screenshot of a smart phone in which the manifest information of the application is displayed is optically recognized.
d) The above various means or terms of use are shared on the Internet.

The application request information type obtaining apparatus 12 provides information requested by the application. For example, this apparatus obtains the information from manifest information of the application.

The application term learning storage apparatus 13 is an apparatus that performs learning for generating application term-of-use vectors from term-of-use information of an application, and stores the application term-of-use vectors. This apparatus includes a feature amount converter, a perceptron, and a database. If the term-of-use information is written in Japanese or Chinese, this apparatus also includes a morphological analyzer that separates words from each other through morphological analysis. This apparatus then converts the words into feature amounts. Examples of an algorithm for converting words into feature amounts include “Bag of Word (BoW)” algorithm.

This apparatus inputs the feature amounts to the multi-layer perceptron, and converts the feature amounts into term-of-use vectors. A term-of-use vector is a numerical representation of terms of use, which is intuitive and linguistically neutral. This apparatus is trained using term-of-use text and terms in advance such that appropriate conversion of terms into vectors can be performed. A large number of terms of use of applications are similar, and thus a probability that terms are converted into more appropriate term vectors (feature amounts) increases as a result of performing training using a larger number of terms of use.

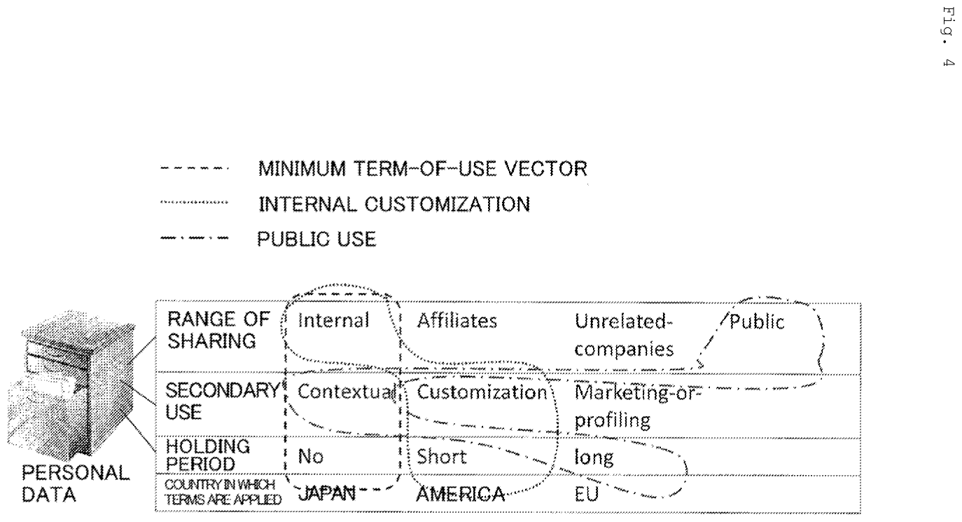

FIG. 4 is a diagram illustrating an example of term-of-use vectors. In FIG. 4, in Privacy Rulesets (see NPL 1), term-of-use vectors are indicated by frame lines. In the example in FIG. 4, components of the vectors are shared range, secondary use, holding period, and country in which the terms are applied, and broken, dotted, and dashed-dotted frame lines indicate term-of-use vectors.

A term-of-use vector may be a discrete combination of one-hot representations. In a one-hot representation, when the component is a country in which the terms are applied, in the vector of the dimension of the number of countries such as [America, Japan, China, . . . ], a target country in which the terms are applied is expressed as “1”, and the others are expressed as “0”. For example, when America is a country in which the terms are applied, the vector is expressed as [1 0 0 0 . . . ]. Such a vector is combined with other vector values. In addition, if vector values are considered to be continuous, the number of components may be one.

This apparatus stores, in the database, calculated term-of-use vectors and application request information obtained from the application request information type obtaining apparatus 12, using the application as a key.

The user's application setting obtaining apparatus 15 is an apparatus that obtains information indicating a location (a folder or the like) in the device (smart phone or tablet) in which the user stores the application, information indicating manual setting (setting on whether or not personal information can be used for each application) performed by the user on the deice, and other information.

The user policy learning storage apparatus 14 is an apparatus that learns and manages a user's privacy policy.

The user policy learning storage apparatus 14 includes: a learning function of holding a user policy of a user learned from terms of use (term-of-use vectors), classifications (folder in which application is installed, or the like), and permitted information (settings on whether or not personal information can be used) for a plurality of applications installed in a terminal, and a checking function of presenting, to the user, permitted information that is recommended based on the user policy when settings of permitted information for one application are changed.

In addition, in the learning function of the user policy learning storage apparatus 14, when the permitted information for the one application is changed, learning is performed again using the changed permitted information, and the user policy is updated. Also, in the checking function, permitted information recommended for another application is presented to the user as necessary based on the user policy updated by the learning function.

In addition, the user policy learning storage apparatus 14 further includes a change function of changing the setting of the permitted information for the application to the permitted information presented to the user by the checking function when an instruction is given from the user, the instruction indicating that a change can be made.

The user policy learning storage apparatus 14 is a perceptron to which term-of-use vectors of an application are input from the application term learning storage apparatus 13, and a folder name to which the application belongs and permitted information of application settings are input from the user's application setting obtaining apparatus 15.

For example, in the case of Android 7, permitted information is displayed by following “application and notification”→“application information”→“permitted” in the control panel. The user can check and set various types of access authorization information of an application on the screen. Permitted information is information for each application to select a function and information from those incorporated in the smartphone.

This perceptron outputs, in correspondence with the above input, information indicating whether or not an information type obtained by the application request information type obtaining apparatus 12 and requested by the application can be obtained. The information output by this perceptron is applied only to the type obtained by the application request information type obtaining apparatus 12. The user policy learning storage apparatus 14 presents, to the user, settings on whether or not personal information can be used by the application, which is information output by this perceptron, and fixes the settings on whether or not personal information can be used, in accordance with a user's instruction indicating that the setting can be performed. Specifically, the user policy learning storage apparatus 14 presents, to the user, settings of permitted information recommended based on the prior and existing user's policy, and settings of permitted information are fixed by the user checking the presented settings.

This apparatus starts at one of the following timings.
[1] When the user installs an application in a device owned by this user.

In this case, this apparatus starts at a timing when user term vectors calculated by an application term learning storage apparatus are input to this apparatus as the application is installed.
[2] When the user stores an installed application to a specific folder in an application management screen on a specific device.

In this case, when information on a folder or the like is input from the user's application setting obtaining apparatus 15 to this apparatus, this apparatus starts, requesting the application term learning storage apparatus 13 for term-of-use vectors of an application of interest. Note that the application management screen is a screen that is first displayed when a smartphone is started, and installed applications are displayed on this screen. The user can classify applications into any folder using the application management screen according to their need. Many users classify applications by purpose, and thus the accuracy of policies can be improved by setting folders as a learning target.
[3] When the user themself manually changes the type of information that can be used for an installed application.

In this case, when the change information is input from the user's application setting obtaining apparatus 15 to this apparatus, this apparatus starts, requesting the application term learning storage apparatus 13 for term-of-use vectors of an application of interest.

In the case of the above timings [1] and [2], fixed permitted information is used as training data for this perceptron.

In addition, in the case of the above timing [3], after this perceptron is trained based on this fixed permitted information, this apparatus checks permitted information for all of the existing applications again, and asks the user to check permitted information that changed before and after training, again.

Note that, if the user ignores or does not confirm permitted information presented by the user policy learning storage apparatus 14, it can be understood that the user intentionally selected the permitted information for existing applications to be different from the recommended permitted information. Therefore, the user policy learning storage apparatus 14 regards it as a user's intention that the application can be permitted to use the permitted information, and gives a feedback to the perceptron using this result as training data again as a learning target.

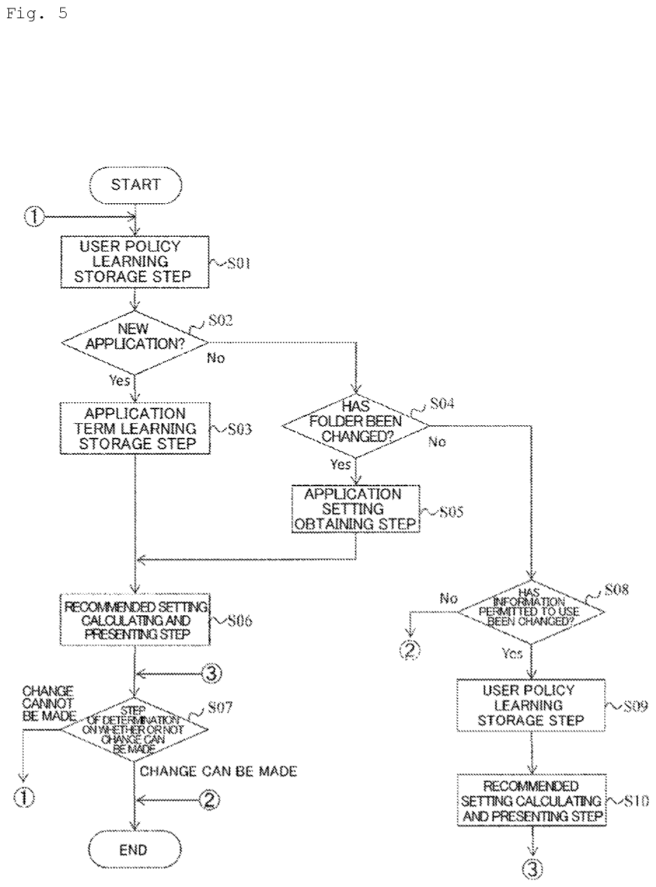

FIG. 5 is a flowchart illustrating a personal information protection method that is performed by the personal information protection apparatus 301.

In a user policy learning storage step S01, the user policy learning storage apparatus 14 learns and stores the user's policy based on term-of-use vectors of an application that have been input from the application term learning storage apparatus 13, and a folder name to which the application belongs and permitted information of application settings that have been input from the user's application setting obtaining apparatus 15.

In a determination step S02, the personal information protection apparatus 301 determines whether or not an application has been newly installed in a device. If no application has been newly installed in the device, the personal information protection apparatus 301 performs a determination step SO4 to be described later.

In the application term learning storage step S03, the application term learning storage apparatus 13 generates application term-of-use vectors based on term-of-use information of the application, and stores the application term-of-use vectors in the database along with application request information obtained from the application request information type obtaining apparatus 12 using the application as a key.

In the determination step S04, the personal information protection apparatus 301 determines whether or not the folder of the installed application has been changed. If the folder of the installed application has not been changed, the personal information protection apparatus 301 performs a determination step S08 to be described later.

In an application setting obtaining step S05, the user's application setting obtaining apparatus 15 obtains information indicating a location (a folder or the like) in which the application was stored, information indicating manual setting that was performed on the device, and other information.

In a recommended setting calculating and presenting step S06, the user policy learning storage apparatus 14 generates permitted information recommended for an application, based on term-of-use vectors of the application that have been input from the application term learning storage apparatus 13, and a folder name to which the application belongs and permitted information set for the application that have been input from the user's application setting obtaining apparatus 15, and presents the permitted information to the user.

In a determination step S07, the user determines whether or not the recommended permitted information presented by the user policy learning storage apparatus 14 can be applied. If the recommended permitted information can be applied, the personal information protection apparatus 301 sets that permitted information for the application, and ends this process. On the other hand, if the recommended permitted information cannot be applied, the personal information protection apparatus 301 does not set the permitted information for the application, and uses the permitted information as training data for the user policy learning storage apparatus 14.

In a determination step S08, the personal information protection apparatus 301 determines whether or not the permitted information of an installed application has been changed. If the permitted information of an installed application has not been changed, this process is ended.

In the user policy learning storage step S09, the user policy learning storage apparatus 14 learns the user's policy again and stores the user's policy based on term-of-use vectors of the application, which have been input from the application term learning storage apparatus 13, and the folder name to which the application belongs and changed permitted information of application settings, which have been input from the user's application setting obtaining apparatus 15.

In a recommended setting calculating and presenting step S10, the user policy learning storage apparatus 14 generates permitted information recommended for an application other than the application for which permitted information has been changed, based on term-of-use vectors of the application, which have been input from the application term learning storage apparatus 13, and a folder name to which the application belongs and permitted information set for the application, which have been input from the user's application setting obtaining apparatus 15, and presents the recommended permitted information to the user. The personal information protection apparatus 301 then performs the determination step S07 for each application.

[Supplementary Note]

Overview of the present invention is given below.

### (1) Issue

Regarding applications that use personal information, laws that are related to information protection, and are applied vary depending on a country and region to which an application creator belongs, and personal information use policies of application creation agencies also vary. Terms of use for confirming them, which are first displayed in an application, are complicated, and a large number of users do not read such terms of use. Therefore, when an application handles personal information, the user does not know whether or not their personal information is appropriately handled, or is adapted to their policy.

### (2) Solution

In a current situation in which use policies for applications in the world are different in each country, the present invention makes it possible to perform appropriate policy management by expressing policies and regions in which laws are applied for applications as vector representations of simple rule sets and performing calculation of these based on terms of use through machine learning and the like, and appropriately detecting contradiction between user's personal information policy and application obtaining information for each application based on changes in user's policy settings and attitude.

Note that vector representation is performed as follows. The information use policy of an application is converted into numerical values or specific words based on “range of information sharing” “secondary use” “information holding period”, and the like, and, in the case of continuous amounts such as numerical values, one numerical value is used as a component, and discrete amounts for a secondary use range or a country in which the terms are applied are converted into One-Hot representation vectors. Vector representations of an information use policy is realized by combining those values and vectors to creating vectors.

### (3) Effect of the Invention

The present invention solves the following problems that devices such as smartphones of today have when application is installed.
a) most users do not read terms of application, and do not check personal information use policies.
b) careless users provide personal information as requested by applications.
c) even if the user's policy on personal information changes, applications installed in the past do not reflect the change.

The present invention solves these problems, and more appropriate distribution of personal information is promoted, and more convenient network services can be provided in societies.

### REFERENCE SIGNS LIST

11 Application term-of-use obtaining apparatus
12 Application request information type obtaining apparatus
13 Application term learning storage apparatus
14 User policy learning storage apparatus
15 User's application setting obtaining apparatus
301 Personal information protection apparatus

1. A personal information protection apparatus that manages, by application, permitted information that is a type of personal information of a user, and is to be used by an application that is installed in a terminal, the apparatus comprising:
a processor; and
a storage medium having computer program instructions stored thereon, when executed by the processor, perform to:
a learning function of holding a user policy of the user learned from terms of use, classifications, and permitted information for a plurality of applications installed in the terminal; and a checking function of presenting, to the user, permitted information that is recommended based on the user policy when a setting of permitted information for one application is changed.

2. The personal information protection apparatus according to claim 1, wherein, in the learning function, when the permitted information for the one application is changed, learning is performed again using the changed permitted information, and the user policy is updated, and in the checking function, permitted information recommended for another application is presented to the user based on the user policy updated by the learning function.

3. The personal information protection apparatus according to claim 1 wherein the computer program instructions further perform a change function of changing the setting of the permitted information for the application to the permitted information presented to the user by the checking function when an instruction is given from the user, the instruction indicating that a change can be made.

4. A personal information protection method for managing, by application, permitted information that is a type of personal information of a user, and is to be used by an application that is installed in a terminal, the method comprising: a learning procedure of holding a user policy of the user learned from terms of use, classifications, and permitted information for a plurality of applications installed in the terminal; and a checking procedure of presenting, to the user, permitted information that is recommended based on the user policy when a setting of permitted information for one application is changed.

5. The personal information protection method according to claim 4, wherein, in the learning procedure, when the permitted information for the one application is changed, learning is performed again using the changed permitted information, and the user policy is updated, and in the checking procedure, permitted information recommended for another application is presented to the user based on the user policy updated by the learning function.

6. The personal information protection method according to claim 4, further comprising: a change procedure of changing the setting of the permitted information for the application to the permitted information presented to the user in the checking procedure when an instruction is given from the user, the instruction indicating that a change can be made.

7. A non-transitory computer-readable medium having computer-executable instructions that, upon execution of the instructions by a processor of a computer, cause the computer to function as the personal information protection apparatus according to claim 1.
